(19) United States
(12) Patent Application Publication
(10) Pub. No.: US 2007/0165826 A1
(43) Pub. Date: Jul. 19, 2007

(54) Telecommunication network comprising a plurality of stacked private networks, private automatic branch exchange for implementing said network, and emergency call center

(76) Inventors: Michel Le Creff, Vigny (FR); Raymond Gass, Bolsenheim (FR)

Correspondence Address: SUGHRUE MION, PLLC, 2100 PENNSYLVANIA AVENUE, N.W., SUITE 800, WASHINGTON, DC, 20037, US

(21) Appl. No.: 11/587,060

(22) PCT Filed: Apr. 4, 2005
(86) PCT No.: PCT/FR05/50269

§ 371 Date: Oct. 20, 2006

(30) Foreign Application Priority Data
Apr. 22, 2004 (FR) 0450766

(51) Int. Cl. H04M 7/00

(52) U.S. Cl. 379/220.01

(57) ABSTRACT

This telecommunication network includes a plurality of private networks (PN11, PN21) which are stacked on at least two levels (L1, L2), each private network (PN11) comprising at least one private automatic branch exchange (PBX11a, PBX11b, PBX11c). At a first level (L1), at least one private network (P11) has at least one first private automatic branch exchange (PBX11c, . . . ) which is connected to a second private automatic branch exchange (PBX21a) of a private network (PN21) belonging to a second level by a line (T4, T5) that can transport the signaling of a private network. This second private automatic branch exchange (PBX21a) is configured with data and routing rules which authorize access to at least one service offered by the second network (PN21) by the first private automatic branch exchange (PBX11c). The two private automatic branch exchanges, which are at the two ends of a line (T4, T5), include software means forming a gateway for number translation, to remedy the fact that the numbering plans of the networks are independent of each other. Moreover, the gateways and the line can transport specific signaling for company networks.

The invention concerns a telecommunication network comprising a plurality of stacked private networks, a private automatic branch exchange, and an emergency call center, for implementing that network. The private networks considered are generally company networks.

A company network is often a set of interconnected private automatic branch exchanges. Each exchange offers particular services in a particular implementation and relies on specific protocols. Each terminal of said network has access to certain services according to an authorization table situated in the private automatic branch exchange to which the terminal is connected, that table or a table portion being specific to that terminal. Subject to authorization, any terminal of this network can activate all the services on each of the private automatic branch exchanges of the network concerned, provided that this is allowed by its own performance, the routing rules, and the configuration data for the private automatic branch exchanges. Activation by a terminal attached to a first private automatic branch exchange of the services offered by a second private automatic branch exchange of the same company network is made possible by sending information over lines connecting the various private automatic branch exchanges of the company network in accordance with signaling protocols. The protocol used is often specific to a private automatic branch exchange manufacturer.

The lines that connect the various private automatic branch exchanges of the same network can take different physical forms:

1. leased lines,

2. switched lines,

3. semi-permanent lines,

4. permanent lines,

5. virtual private network type lines provided by a third party operator,

6. etc.

Each terminal of a company network is identified by a directory number that belongs to a numbering plan specific to that network. In the same network, each directory number is unique.

When a terminal attached to a first private automatic branch exchange calls another terminal attached to a second private automatic branch exchange of the same company network, that second private automatic branch exchange is looked up in a routing table that designates a signaling line for connecting the first and second private automatic branch exchanges in order to send signaling information to the second exchange.

When a terminal attached to a first private automatic branch exchange calls another terminal attached to another company network, the call must generally pass through a public network that provides only a basic telephone service. The basic telephone service is sufficient for simple calls between two independent company networks, but it does not offer sophisticated functions. Sophisticated telephone functions would be very useful, especially in the case of an emergency call to an emergency call center set up at the request of a terminal of a company network.

The above limitations are the result of existing techniques for connecting nodes of company networks. These techniques use specific signaling protocols that cannot be used beyond an access node to the public network when it is a question of setting up a call to another company network via a public network. For calls between two independent company networks, the line between the last node of the first company network and the first node of the second public network conventionally uses a signaling protocol known as the Q.931 protocol. However, the signaling protocols used within the first and second company networks are different from the Q.931 protocol and may be different from each other.

Moreover, the numbering plans of the company networks are totally independent, to the extent that the same number may be assigned at the same time to an equipment of a first company network and to another equipment of a second company network. Combining the two numbering plans in the event of interconnection of two independent company networks would give rise to a problem with routing calls. Combining them therefore cannot be envisaged except by producing a new, unique and common numbering plan corresponding to a merging of the two networks to constitute one and the same network, which in most cases proves impossible.

Finally, the company networks may be architectured around gateway nodes. Signaling protocols of the QSIG-GF (Q Signaling-Generic Functions) type are used to manage the gateway nodes and to address them individually. In independent company networks there is nothing to exclude gateway nodes having the same addresses in the two networks. This gives rise to an additional problem for interconnecting two company networks.

The document U.S. Pat. No. 6,650,632 describes a system for interconnecting two company networks via a public network. A basic telephone connection routes signaling messages that can be supported by the signaling protocol used in the public network concerned. Each of these company networks includes a gateway for creating an auxiliary connection for transmitting signaling messages that cannot be supported by the signaling protocol used in the public network. This auxiliary connection is completely independent of the basic telephone connection. For example, it passes through the Internet public network. However, this known system does not address the problem of independent numbering plans. This system therefore necessitates two networks having the same numbering plan. This system therefore cannot be used for collaboration of two independent private networks that already exist, i.e. when it is in practice impossible to merge their respective numbering plans into a single numbering plan. It is only possible to have them communicate via the basic telephone service provided by the public telephone network, i.e. without providing the additional services that are usually provided in each of the two company networks.

More generally, the object of the invention is to enable two private networks to collaborate, in order to provide certain precisely defined services, at the same time as preserving the independence of their numbering plans and the independence of all their services that this collaboration does not concern.

The services concerned are those that have a common interest, especially a common commercial interest, for a plurality of private networks. For example, in the automotive industry field, different vehicle manufacturers use common parts or subassemblies to construct vehicles of different marques. Consider the engine, which is an essential component. Certain engines are designed and manufactured by an “engine” company independent of the car manufacturers, even if there may be special financial links between them. The “engine” company has its own telecommunication network, as do the car manufacturers. It is desirable for a mechanic in a workshop of one of the car manufacturers to be able to call a contact in the “engine” company when carrying out a difficult repair or to access directly a technical database of the “engine” company. All these lowest level (car manufacturer) networks therefore need to communicate with a higher level (“engine” company) network of this hierarchy.

Calls between these two levels generally use a standard telephone connection in the public telecommunication network. A consequence of this is that the calls benefit from services that are less rich than those provided in each of the company networks, respectively that of the engine company and that of the car manufacturers.

It is also desirable for a mechanic of a first manufacturer to be able to communicate with a counterpart of a second manufacturer (via two networks at the same level), for example to solve a shared technical problem concerning an engine, with the benefit of services richer than those available in the public network.

The network according to the invention is also applicable to the field of emergency call centers. An emergency call center is intended to receive all emergency telephone calls made in a given region. All telephone calls to a generic number (112 in Europe, 911 in the USA) are automatically routed to an emergency call center dedicated to the region concerned. An emergency call that emanates from a private network belonging to a company is usually carried by a standard telephone line of the public telecommunication network. Even in the best case scenario, a public network provides only the number of the terminal.

If the call emanates from an ISDN (Integrated Services Digital Network) type public telephone network, the public network sends the line number of the calling terminal to the call center. In the USA, where integrated services digital networks are not available in certain states, a separate signaling network and a protocol known as the CAMA (Centralized Automatic Message Accounting) protocol are used inter alia to send the line number of the calling terminal in the form of multifrequency signals.

In these two cases, the call center then uses a database to determine the location of the calling terminal from its line number.

An emergency call center may itself include a company network type private network offering sophisticated services to calls within the private network. However, because an emergency call passes through the public network, it cannot at present benefit from the sophisticated services available either within the calling company network or within the company type network of the emergency call center.

For example, it may be envisaged that the parent private automatic branch exchange of the calling terminal provides, in addition to services that send the caller number and automatically locate the caller, additional services such as:
activation by an emergency call center operator of an enquiry call,
maintaining a call even after the caller requests clearing down,
consulting a directory internal to the company network,
automatic ringback,
call intrusion,
at the request of an emergency call center, locating a terminal that has not called, to locate a person liable to be in a hazardous situation,
consultation of the internal directory of the company by emergency call center personnel,
remote activation of alarm devices in the company by emergency call center personnel,
broadcasting an alarm message to all the telephones of the company.

In the current state of the art, the richness of the services made available to an emergency call center by a company network and vice-versa is limited because their collaboration is limited because they communicate via a basic telephone service.

The object of the invention is to propose a method that overcomes this limitation.

The invention consists in a telecommunication network including a plurality of company networks having respective independent numbering plans characterized in that it includes at least one company network having at least one first private automatic branch exchange including a first gateway providing number translation and at least one other company network having at least one second private automatic branch exchange including a second gateway providing inter alia number translation, in that these two gateways are connected by a line, and in that these two gateways and this line are capable of transporting signaling specific to company networks.

For example, a first independent private network has a private numbering plan PNP1, a second private network has a private numbering plan PNP2 and these numbering plans PNP1 and PNP2 have identical numbers for designating different terminals. For example two terminals respectively belonging to these two networks are designated by the same number 4321. Each of these two terminals is called within its own network by entering the digits 4321. According to the invention, number translation is operative for a call from the first network to the second network and vice-versa.

For example, when the terminal designated by the number 4321 in the second network is called from the first network, it is designated as far as the output of the first network by a number that is outside the numbering plan of the first network, for example 64321, so that it is possible to route the call across the first network without error. To call the terminal 4321 in the second network, a user on the first network therefore enters 64321 on the keypad of a telephone terminal. The call set-up request is routed to a private automatic branch exchange that enables access to the public network and includes a number translation gateway conforming to the invention. When the call set-up request passes through this gateway to be connected through to the second private network via a public network, the gateway translates the number 64321 into a number 4321 that is perfectly usable for routing in the second network.

In a similar way, the terminal 4321 of the first network is designated as far as the output of the second network by a number that is outside the numbering plan of the second network, for example 74321, so that it is possible to route the call through the second network. The number 74321 is translated into a number 4321 by a number translation gateway situated at the output of the second network.

Thanks to this number translation, the two company networks can communicate without being obliged to pass through the basic telephone service because the respective numbering plans of the two company networks are incompatible. They can therefore collaborate to provide company network type services, provided that they can exchange signaling supporting such services. A problem may remain: if the two company networks use different signaling protocols, they cannot exchange signaling directly. According to the invention, said gateways and the line are capable of transporting signaling specific to a company network.

According to one particular embodiment, the network is characterized in that at least one of said gateways further provides functions of transcoding information between the signaling protocol used in the company network to which it belongs and the signaling protocol used on the line.

The network thus characterized enables independent first and second private networks to communicate using different internal signaling protocols that are possibly incompatible with crossing a public network. For example, the first private network uses the QSIG protocol and the second private network uses the PSS1 protocol of the H.245 standard. Under these conditions, they would not be able to communicate directly. The gateways situated at the ends of the line then provide signaling protocol transcoding in both directions. If necessary, they use a third signaling protocol on the line between the two networks, for example the standard Session Initiation Protocol (SIP), which can be transmitted over the public network. Each private network can therefore retain its own signaling protocol and the common signaling protocol is used only to cross the public network. The SIP enables a great diversity of services and is particularly well adapted to the transmission of information over the Internet network.

Signaling information conforming to the QSIG protocol from the first network is transcoded into the Session Initiation Protocol before it is transmitted over the line connecting the two networks. At the input of the second network it is transcoded into the PSS1 protocol. Likewise, signaling information conforming to the PSS1 protocol of the H.245 standard from the second network is transcoded into the Session Initiation Protocol before it is transmitted over the line connecting the two networks. At the input of the first network it is transcoded into the QSIG protocol.

It is possible for one of the two networks to use the same protocol (for example the SIP) as the line connecting the two networks, whereas the other network uses a different protocol. In this case, the first network does not necessitate protocol transcoding in its gateway whereas the other network does perform protocol transcoding in its gateway.

Of course, other lines are used to convey the traffic information (voice, data) for the call between the users of the terminals. These traffic lines are determined by the private networks when they exchange information over the signaling lines.

In a preferred embodiment, the network is characterized in that the first private automatic branch exchange is configured with data and routing rules authorizing access by the first private automatic branch exchange to at least one service offered by the second private automatic branch exchange.

In a preferred embodiment, the network is characterized in that the second private automatic branch exchange is configured with data and routing rules authorizing access by the first private automatic branch exchange to at least one service of the second private automatic branch exchange.

In a preferred embodiment, the network is characterized in that the second private automatic branch exchange is configured with data and routing rules authorizing access by the second private automatic branch exchange to at least one service of the first private automatic branch exchange.

In a preferred embodiment, the network is characterized in that the first private automatic branch exchange is configured with data and routing rules authorizing access by the second private automatic branch exchange to at least one service offered by the first private automatic branch exchange.

In a preferred embodiment, the network is characterized in that the first private automatic branch exchange is configured with data and routing rules prohibiting access by all the other company networks of the first level to all its services via the second level.

The network thus characterized maintains the independence of the private networks, at the same time as enabling them to collaborate for precisely defined services.

The network according to the invention may be constituted of an emergency call center and several company networks situated in an area served by that center. In this case, in the event of an emergency call emanating from a private automatic branch exchange of one of the company networks, the emergency call center benefits from enriched services because the parent private automatic branch exchange of the calling terminal is transformed into a virtual node of the network of the emergency call center, at least for certain predetermined services agreed with the company that owns the private automatic branch exchange: on the one hand, the parent private automatic branch exchange of the calling terminal is connected to the private automatic branch exchange of the emergency call center by a line capable of transporting the signaling of a company network, i.e. enabling the transmission of richer signaling than can be transmitted by a basic telephone line in a public network, and, on the other hand, it is possible to overcome the inconsistency of the numbering plans thanks to the number translation effected by the two gateways.

For example, if an emergency call center receives an emergency call coming from a private network belonging to a company, the private automatic branch exchange of the call center routes the call to a human operator with whom the caller converses. That operator is provided with at least one telephone terminal and possibly with other equipment such as a PC. During a call, the emergency call center operator may be called on to activate additional services available on the private automatic branch exchange of the company: for example to set up a three-way conference call with another user of the calling company network.

To provide this kind of three-way conference call, the emergency call center sends the necessary commands over the signaling line set up by the private automatic branch exchange of the company during the emergency call. These commands look someone up in the directory of the private network, call that person and add him to the conference call. To set up this three-way conference call, the private automatic branch exchange of the company verifies the signaling information coming from the private automatic branch exchange of the emergency call center over the signaling line. The verification is effected by means of authorization tables that indicate in particular the services that an emergency call center is. authorized to access during an emergency call.

A second aspect of the invention consists in a private automatic branch exchange for a company network, characterized in that it includes:
means for connecting it to another private automatic branch exchange of another company network via a tunnel line across a public network, and
a gateway providing number translation.

A third aspect of the invention consists in an emergency call center including at least one such private automatic branch exchange.

The invention will be better understood and other features will become apparent in the light of the following description and the accompanying figure.

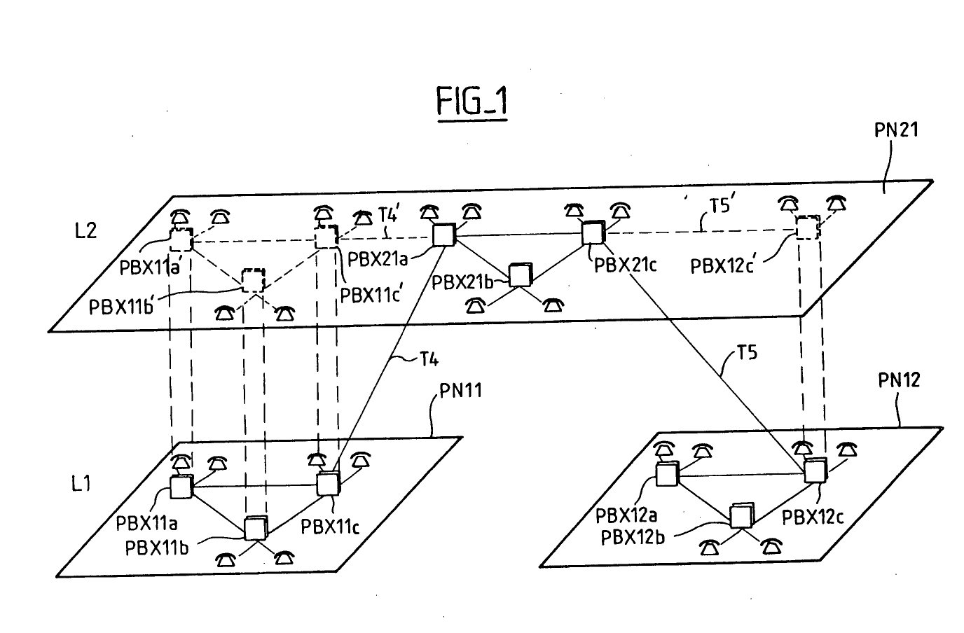

FIG. 1 is a functional representation of a first embodiment of a network according to the invention.

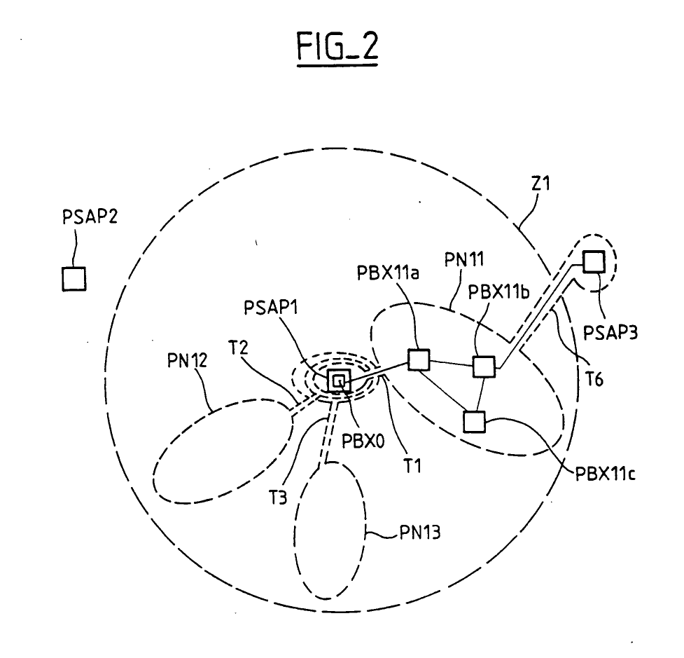

FIG. 2 is a functional representation of a second embodiment of a network according to the invention in which there are three emergency call centers.

The example represented in FIG. 1 is a telecommunication network constituted on two levels:
A lower level L1 constituted of two company networks PN11 and PN12. The network PN11 includes three interconnected private automatic branch exchanges PBX11a, PBX11b, PBX11c. The network PN12 includes three interconnected private automatic branch exchanges PBX12a, PBX12b, PBX12c.
A higher level L2 constituted of a single company network PN21 including:
Three interconnected private automatic branch exchanges PBX21a, PBX21b, PBX21c.
Three virtual private automatic branch exchanges PBX11a′, PBX11b′, PBX11c′ that in reality belong to the company network PN11 of the lower level L1. They are interconnected, as in the network PN11. Moreover, the private automatic branch exchange PBX11c′ is connected to the private automatic branch exchange PBX21 a by a virtual line T4′ that is the image of a real line T4 known as a tunnel line between the private automatic branch exchanges PBX21a and PBX11c via a public telecommunication network that is not shown.
A virtual private automatic branch exchange PBX12c′ which in reality belongs to the company network PN12 of the lower level L1 and which is connected to the private automatic branch exchange PBX21 c by a virtual line T5′ that is the image of a real line T5, which is a tunnel line between the private automatic branch exchanges PBX21c and PBX12c via a public telecommunication network that is not shown.

Each line between company networks, such as the line T4 or T5, is a company network artery, which may cross a public network:
by means of a dedicated line; or
by means of a connection set up on demand, permanently or semi-permanently, or call by call; or
by means of a portion of the user to user signaling (SUU) band of the ISDN (Integrated Services Digital Network); or
by means of H.225 or SIP containers.

A tunnel line is usually employed to connect two remote sites of the same company via the public network. The tunnel line guarantees the authenticity and the confidentiality of the voice signals and other data while crossing the public network. It is also used to transmit rich signaling, using inter alia the QSIG protocol, which is a standard signaling protocol for company networks.

To set up a connection of this kind via a public network, each private network PN11, PN12, PN21 includes at least one gateway that inter alia provides number translation. In the example represented, the private automatic branch exchanges PBX21a and PBX11c each include software means constituting a gateway for setting up the line T4 and the private automatic branch exchanges PBX21c and PBX12c each include software means constituting a gateway for setting up the line T5.

Number translation is necessary to enable correct routing of calls despite the fact that the numbering plans of the different networks PN21, PN11, PN12 are independent. In fact, two terminals belonging to two independent private networks (for example the networks PN21 and PN11) can have identical call numbers in the numbering plans of the respective networks to which the terminals belong.

A second condition necessary for satisfactory collaboration between a plurality of independent private networks is control of the rights of access to the services that each is able to provide. Conventionally, a company network private automatic branch exchange is configured with various tables managed by software, for example directory tables, category tables, service access authorization/prohibition tables, routing tables, etc. Each node of the same company network includes some or all of these tables. All the nodes of the same network offer substantially the same services. Access to each service is authorized or prohibited terminal by terminal in the tables of the parent private automatic branch exchange of the terminal concerned.

Conventionally, when a terminal requests the setting up of a call or requests a service, software is executed in the node to which that terminal is attached. This software authorizes the requested action or not, as a function of the content of the tables of this node. If the call or the service requested connects this first node with a second node of the same network, the second node executes the requested action without carrying out any checks using its own software and its own tables. For example, if a user connected to a first node of a company network requests the setting up of an international call and this first node has no direct link to the public network, the call request must be routed to a second node of this company network which has a direct link to the public network. In this case, the first node verifies in its tables that this user has the right to request the setting up of an international call and determines that it must route the call via the second node. A request to set up an international call is then sent to the second node. The second node receives this request and sets up a path to the public network without further checking the users rights. In other words, in a conventional company network, the node requesting an action performs the access authorization and/or prohibition verifications whereas the destination node does not perform any verification.

According to the invention, in addition to any verifications carried out by the node requesting an action, verifications are carried out by the destination node and/or by an intermediate node.

1) According to the invention, the private automatic branch exchange PBX21 of the network PN21 is configured with data and routing rules authorizing access by the private automatic branch exchange PBX11cof the lower level L1 to at least one service offered by the network PN21 of the higher level L2 and prohibiting access by the private automatic branch exchange PBX11c to all the other services of the network PN21a. For example, the company network PN21 belongs to an “engine” company whereas the company networks PN11 and PN12 respectively belong to two car manufacturers. A mechanic in a workshop of one of the car manufacturers has a telephone terminal connected to the private automatic branch exchange PBX11c and wishes to set up a call to the telephone terminal of an expert of the “engine” company connected to the private automatic branch exchange PBX21a. The mechanic enters the call number of the telephone of the expert in a number format specific to the company network PN11 of the car manufacturer. Using its software and its various tables, the private automatic branch exchange PBX11c verifies that the terminal of this mechanic has the right to set up a call to the network PN21 of the “engine” company. It then determines that it must route the call to the private automatic branch exchange PBX21a via the line T4. The gateway integrated into the private automatic branch exchange PBX11c translates the number into the format corresponding to the numbering plan of the destination network PN21. The private automatic branch exchange PBX21a receives this call set-up request. Using its software and its various tables, it verifies that the terminal of this mechanic and/or the private automatic branch exchange PBX11c has the right to set up a call to the terminal of the called expert; finally, it sets up the call.

2) In one particular embodiment, the private automatic branch exchange PBX11c of the network PN11 of the lower level L1 is configured with data and routing rules authorizing access by the private automatic branch exchange PBX21a of the higher level L2 to at least one service offered by that private automatic branch exchange PBX11c. For example, an expert of the “engine” company whose telephone terminal is connected to the private automatic branch exchange PBX21 a wishes to set up a call to a mechanic in a workshop of one of the car manufacturers whose terminal is attached to the private automatic branch exchange PBX11c. The expert enters the call number of the terminal of the mechanic in a number format specific to the company network PN21 of the “engine” company. Using its software and its various tables, the private automatic branch exchange PBX21a verifies that the terminal of that expert has the right to set up a call with the private automatic branch exchange PBX11c of the car manufacturer and determines that it must route the call to the private automatic branch exchange PBX11c via the line T4. The gateway integrated into the private automatic branch exchange PBX21a translates the number into the format corresponding to the numbering plan of the destination network PN11. The private automatic branch exchange PBX11c receives this call request. Using its software and its various tables, it verifies that the terminal of this expert and/or the private automatic branch exchange PBX21 a has the right to set up a call to the requested terminal; finally, it sets up the call.

3) In one particular embodiment, to keep the networks PN11 and PN12 completely independent, the private automatic branch exchange PBX21a of the network PN21 is configured with data and routing rules prohibiting access by the other company network PN12 of the first level L1 to all the services of the network PN11 via the higher level L2. For example, a mechanic in a workshop of a car manufacturer has a telephone terminal attached to the private automatic branch exchange PBX12c and wishes to set up a call to a mechanic in a workshop of another car manufacturer connected to the private automatic branch exchange PBX11c via the company network PN21 of the “engine” company. The private automatic branch exchange PBX21c receives this call request. Using its software and its various tables, it verifies if the private automatic branch exchange PBX12c has the right to set up a call to the private automatic branch exchange PBX11c. It finds that it does not have that right, and therefore refuses to set up the call.

4) In one particular embodiment, the private automatic branch exchange PBX21a of the network PN21 is configured with data and routing rules authorizing access by the company network PN12 of the lower level L1 to at least one service of the network PN11 of the lower level L1 to authorize certain exchanges between the networks of the lower level L1 via the higher level L2. For example, a mechanic in a workshop of one of the car manufacturers has a telephone terminal attached to the private automatic branch exchange PBX12c. He wishes to set up a call to a mechanic in a workshop of another car manufacturer having a telephone terminal attached to the private automatic branch exchange PBX11c via the company network PN21 of the “engine” company. The private automatic branch exchange PBX21c receives this call request. Using its software and its various tables, it verifies that the private automatic branch exchange PBX12c has the right to set up a call to the private automatic branch exchange PBX11c. Finally, it sets up the call. The gateways integrated into the private automatic branch exchanges PBX12, PBX21c, PBX21a, PBX11c perform the necessary number translation.

5) In another particular embodiment, to guarantee that the networks PN11 and PN12 remain completely independent, the private automatic branch exchange PBX11c of the network PN11 of the lower level L1 is configured with data and routing rules prohibiting access by the other company network PN12 of the lower level L1 to all its services via the higher level L2. Consider, for example, a mechanic in a workshop of one of the car manufacturers. He has a telephone terminal attached to the private automatic branch exchange PBX12c. He wishes to set up a call to a mechanic in a workshop of another car manufacturer having a telephone terminal attached to the private automatic branch exchange PBX11c via the company network PN21 of the “engine” company. This example assumes that the network PN21 accepts transmission of the call setup request to the private automatic branch exchange PBX11c. The private automatic branch exchange PBX11c receives this call request. Using its software and its various tables, it verifies that the private automatic branch exchange PBX12c has the right to set up a call to the private automatic branch exchange PBX11c. The private automatic branch exchange PBX11c finds that it does not have this right, and therefore refuses to set up the call.

The invention may be applied to emergency call centers. Emergency call centers have a particular feature, however: in the same private network, an emergency call initiated on a site A, for example by entering the number 112, should be connected through to a call center PSAPa, whereas an emergency call launched on a site B, by entering the same number 112, should be connected through to a call center PSAPb, each of the centers PSAPa and PSAPb having a different number in the E164 type numbering plan of the public network. The parent private automatic branch exchange of the calling terminal on the site A translates the number 112 entered on the site A into a first E164 type number. The parent private automatic branch exchange of the calling terminal on the site B translates the number 112 entered on the site B into a second E164 type number.

The following tables, in which P1, P2, PL respectively denote the protocols of network 1, network 2 and the line, summarize the different situations encountered in respect of number translation and signaling protocol conversion:

| Signaling protocols | Signaling protocol transcoding |
|---|---|
| P1 = PL = P2 | Of no utility |
| P1 = PL ≠ P2 | In the network 2 gateway |
| P1 ≠ PL = P2 | In the network 1 gateway |

| | | Translation of number in |
|---|---|---|
| | | gateway (assuming that |
| | Translation of | gateway is not integrated |
| | number in parent | into caller's parent private |
| | private automatic | automatic branch |
| Call | branch exchange | exchange) |
| Call a private type | No | Yes |
| number | | |
| Call a public and | Yes | No |
| generic type number | | |
| (112 or 911) | | |
| Call an ordinary | No | No |
| public type number | | |

FIG. 2 represents diagrammatically a second example of a network according to the invention in which there are three emergency call centers PSAP1, PSAP2, PSAP3. The emergency call center PSAP1 serves a geographical area Z1 in which are situated inter alia three company telecommunication networks PN11, PN12, PN13. The emergency call centers PSAP1, PSAP2, PSAP3 themselves constitute a network via lines that are not shown. Each emergency call center is a company network type network primarily including a private automatic branch exchange such as the private automatic branch exchange PBX0 of the center PSAP1. Moreover, they are connected to a public telephone network by lines that are not shown. The public network (not shown) may be analog or digital.

Each company network PN11, PN12, PN13 includes at least one private automatic branch exchange. For example, the company network PN11 includes three interconnected private automatic branch exchanges PBX11a, PBX11b, PBX11c.

According to the invention, the private automatic branch exchanges of the company network PN11, the company network PN12 and the company network PN13 are configured as virtual nodes of the company network of the center PSAP1. Consequently, the telephones (not represented) of the center PSAP1 not only benefit from the services provided by the private automatic branch exchange PBX0 of the center PSAP1 but may further benefit from certain services provided by the private automatic branch exchanges PBX11a, PBX11b, PBX11c of the company network PN1. They can likewise benefit from certain services provided by the private automatic branch exchanges (not shown) of the company networks PN12 and PN13.

The private automatic branch exchange PBX0 of the emergency call center is configured with data and routing rules so that it does not compromise the independence of the company networks PN1, PN2, PN3. The list of services to which the private automatic branch exchange PBX0 has the right of access is limited and is decided on beforehand with the agreement of the companies that are the proprietors of the company networks PN1, PN2, PN3. For this purpose, each private automatic branch exchange PBX11a, PBX11b, PBX11c is configured with data and routing rules authorizing access to at least one service offered by the private automatic branch exchange but prohibiting access to other services by any other private automatic branch exchange that does not belong to the same company network PN11. The same applies in the other company networks PN12 and PN13.

To communicate with the company network PN11, the private automatic branch exchange PBX0 is connected to the private automatic branch exchange PBX11a by a tunnel type line T1 supported by a public telephone network. Software means constituting a gateway are integrated into the private automatic branch exchange PBX0 at the end of the line T1, in particular to perform number translation. Likewise, a gateway is integrated into the private automatic branch exchange PBX11a at the end of the line T1, inter alia for number translation.

The private automatic branch exchanges PBX11a and PBX11c are served by the emergency call center PSAP0 whereas the private automatic branch exchange PBX11b of the same network PN11 is served by the call center PSAP3, for example for reasons of geographical proximity. To communicate with the company network PN11, the private automatic branch exchange PBX3 is connected to the private automatic branch exchange PBX11b by a tunnel type line T6 supported by a public telephone network. Software means constituting a gateway are integrated into the private automatic branch exchange PBX3 at the end of the line T6, inter alia to perform number translation. Similarly, a gateway is integrated into the private automatic branch exchange PBX11b at the end of the line T6, inter alia to perform number translation.

More precisely, when a user of the company network PN1 enters a generic emergency number (for example 112 in Europe, 911 in the USA) on a telephone attached to the private automatic branch exchange PBX11c, that generic number is recognized by the private automatic branch exchange PBX11c and that private automatic branch exchange PBX11c looks up in a routing table a number from the E164 type numbering plan of the public network designating a predetermined emergency call center that serves the geographical area in which the private automatic branch exchange PBX11c is situated. In this example, this is the center PSAP1. The private automatic branch exchange PBX11c does not itself have an access gateway to the public network. The call is routed first to the private automatic branch exchange PBX11a that provides access to the public network, more precisely to the region in which the center PSAP1 is situated. In this situation the gateway integrated into the private automatic branch exchange PBX11a performs protocol conversion but not number translation, since the called number is now a number from the numbering plan of the public network and not a number of the private network of the center PSAP1. The call remains virtually within the company network of the center PSAP1.

When a user of the company network PN11 enters a generic emergency number on a telephone attached to the private automatic branch exchange PBX11b, that generic number is recognized by that private automatic branch exchange and that private automatic branch exchange looks up in a routing table a number from the E164 type numbering plan of the public network designating a predetermined emergency call center which serves the geographical area in which the private automatic branch exchange PBX11b is situated. In this example this is the center PSAP3. The private automatic branch exchange PBX11b itself has an access gateway to the public network, more precisely the region in which the center PSAP3 is situated. This call is therefore routed directly from the private automatic branch exchange PBX11b to the public network via the line T6. In this situation the gateway integrated into the private automatic branch exchange PBX11b performs protocol conversion but not number translation. The call remains virtually within the company network of the center PSAP3.

The other company networks PN12, PN13 are connected in analogous manner to the private automatic branch exchange PBX0 via tunnel lines T2 and T3 and the private automatic branch exchange PBX0 of the emergency call center PSAP1 is configured as a node of the company network PN12 and a node of the company network PN13 without compromising the independence of the three company networks. In particular, it is configured so that it is not possible to pass a call from one company network PN11, PN12, PN13 to another and is also configured as a node of the network of the emergency call centers PSAP1, PSAP2, PSAP3, and therefore enables call transfer from one center to another.

The document ECMA-133, December 1998, describes the reference configuration of private automatic branch exchanges interconnected by tunnel lines to constitute a company network.

The private automatic branch exchange PBX0 of the emergency call center PSAP1 preferably exchanges signaling messages with the private automatic branch exchanges of the company networks in accordance with the standard QSIG signaling protocol. On the other hand, the signaling protocol is preferably transported across the public telephone network in a tunnel line protocol. The choice of this tunnel line protocol depends firstly on the capabilities of the public network. For example, it is:
the SUU3 protocol of the Q.931 standard for an integrated services digital network type public network, or
the H.255 protocol for an Internet type public network using the H.323 protocol family, or
the SIP for an Internet type public network using the SIP.

This signaling protocol is preferably encapsulated in a tunnel line protocol so that the content of the messages exchanged remains authentic and confidential despite crossing the public network. The tunnel line protocol may be the Q.931 protocol, the SIP or the H.323 protocol.

The scope of the invention is not limited to a particular signaling protocol and to a particular tunnel line protocol. Nor is it limited to two levels. FIG. 1 represents only two levels but other combinations are possible. For example, it is possible to add additional levels (3, 4, . . . , n) by considering that the second level in which the network PN21 is situated may include other networks PN22, PN23, . . . , PN2n, and that at least one additional level, a level L3, for example including a network PN31, may be connected to any network of the other levels L1 and L2. Thus the network PN31 could be connected to the networks PN21, PN22, PN11, PN1n by tunnel lines T7, T8, . . . , Tn (not shown).

1. Telecommunication network including a plurality of company networks (PN11, PN21) having respective independent numbering plans characterized in that it includes at least one company network (P11) having at least one first private automatic branch exchange (PBX11c, . . . ) including a first gateway providing inter alia number translation and at least one other company network (P21) having at least one second private automatic branch exchange (PBX21a) including a second gateway providing inter alia number translation, in that these two gateways are connected by a line (T4, T5), and in that these two gateways and this line (T4, T5) are capable of transporting signaling specific to company networks.

2. Network according to claim 1, characterized in that at least one of said gateways further provides functions of transcoding information between the signaling protocol used in the company network to which it belongs and the signaling protocol used on the line.

3. Network according to claim 1, characterized in that the first private automatic branch exchange (PBX11c) is configured with data and routing rules authorizing access by the first private automatic branch exchange (PBX11c) to at least one service offered by the second private automatic branch exchange (PBX21a).

4. Network according to claim 1, characterized in that the second private automatic branch exchange (PBX21a) is configured with data and routing rules authorizing access by the first private automatic branch exchange (PBX11c) to at least one service of the second private automatic branch exchange (PBX21a).

5. Network according to claim 1, characterized in that the second private automatic branch exchange (PBX21a) is configured with data and routing rules authorizing access by the second private automatic branch exchange (PBX21a) to at least one service of the first private automatic branch exchange (PBX11c).

6. Network according to claim 1, characterized in that the first private automatic branch exchange (PBX11c) is configured with data and routing rules authorizing access by the second private automatic branch exchange (PBX21a) to at least one service offered by the first private automatic branch exchange (PBX11c).

7. Network according to claim 1, characterized in that the first private automatic branch exchange (PBX11c) is configured with data and routing rules prohibiting access by all the other company networks (PN12) of the first level (L1) to all its services via the second level (L2).

8. Network according to claim 1, characterized in that this second private automatic branch exchange (PBX0) belongs to an emergency call center (PSAP1) and in that each private automatic branch exchange (PBX11a, PBX11b, PBX11c) of the first network includes means for translating a generic emergency number (112, 911) into a number belonging to the numbering plan of a public network and specific to an emergency call center.

9. Network according to claim 1, characterized in that the two gateways are connected by a public telephone network and in that each includes means for transporting the QSIG signaling protocol across this public telephone network in a tunnel line protocol.

10. Private automatic branch exchange (PBX21a) for a company network, characterized in that it includes:
means for connecting it to another private automatic branch exchange (PBX11c) of another company network via a tunnel line across a public network, and
a gateway providing number translation.

11. Emergency call center (PSAP1) characterized in that it includes a company network (PN21) including at least one private automatic branch exchange (PBX21a) according to claim 10.

12. Emergency call center according to claim 11, characterized in that this private automatic branch exchange (PBX21a) is connected to at least one other company network (PN11) and is configured with data and routing rules authorizing access to at least one service offered by that private automatic branch exchange (PBX21a) by any private automatic branch exchange belonging to that other company network (PN11).

13. Emergency call center (PN21) according to claim 11, serving an area including in particular a plurality of other company networks (PN11, PN12, . . . ), characterized in that, to maintain the independence of those company networks, each private automatic branch exchange (PBX21a, PBX21b, PBX21c) belonging to the network of this emergency call center (PN21) is configured with data and routing rules prohibiting access by each of those other company networks to all the services of each of those other company networks (PN11, PN12, . . . ).
